(19) United States
(12) Patent Application Publication
(10) Pub. No.: US 2011/0138313 A1
(43) Pub. Date: Jun. 9, 2011

(54) VISUALLY RICH TAB REPRESENTATION IN USER INTERFACE

(76) Inventors: Kevin Decker, San Jose, CA (US); Jing Jin, Sunnyvale, CA (US); Raymond Sepulveda, San Jose, CA (US); Michael Thole, San Francisco, CA (US); John William Sullivan, Pacific Grove, CA (US)

(21) Appl. No.: 12/630,759

(22) Filed: Dec. 3, 2009

(51) Int. Cl. G06F 3/048

(52) U.S. Cl. 715/777; 715/838; 715/781

(57) ABSTRACT

Methods and apparatuses that generate a thumbnail image for each tab in a window based on a snapshot of the window providing interface for a presentation corresponding to the tab are described. An expanded tab bar may be displayed to replace a tab bar inside the window. One or more thumbnail images may be displayed in the expanded tab bar. A user interface operation may be detected on a particular thumbnail image in the expanded tab bar to update the window for providing interface for a particular presentation corresponding to the particular thumbnail.

### CROSS REFERENCE

The present application is related to U.S. patent applications Ser. No. 12/549,338 filed on Aug. 27, 2009, now pending, Ser. No. 11/760,759, filed on Jun. 9, 2007, which has been published on Dec. 11, 2008, publication No. US2008/0807343 A1, now pending, the disclosures of which are hereby incorporated herein by reference in their entirety.

### BACKGROUND

Data processing systems, such as general purpose computers, often employ tabs in a window to allow switching among multiple presentations using the same window for graphical user interface on the screen of a display device. Typically, tabs are designed to take up only a small portion of display real estate in a window. As a result, each tab is usually identified via a text label with small font size. To further save display space for a window, multiple tabs are commonly presented overlapping with each other.

However, tabs are usually labeled in small size fonts. It may not be user friendly to identify a tab by a small text label. This is especially true when the number of tabs is large and the tabs appear crowded. Worse yet, as the tabs are displayed overlapping with each other, additional user actions to reveal hidden tabs may be required for tab identification.

Therefore, traditional representation of tabs can create confusion and clutter when switching presentations in a window for a graphical user interface.

### SUMMARY OF THE DESCRIPTION

An embodiment of the present invention can include methods and apparatuses that generate a thumbnail image for each tab in a window based on a snapshot of the window providing an interface for a presentation corresponding to the tab. In one embodiment, an expanded tab bar may be displayed to replace the tab bar inside the window. One or more thumbnail images may be displayed in the expanded tab bar. The thumbnail images may be morphed or displayed (e.g. in response to a command received while the expanded tab bar is displayed) from the expanded tab bar into snapshot images arranged in a two dimensional grid over an area covering at least a center portion of the window. A user interface operation may be detected on a particular snapshot image to update the window for providing interface for a particular presentation corresponding to the particular snapshot image.

In another embodiment, snapshot images may be generated to present tabs in a tab bar of a window. Each snapshot image for a tab may indicate the window providing interface for a separate presentation corresponding to the tab. An area covering an center portion of the window on a display screen may be determined for the snapshot images. In one embodiment, the area may be constrained according to a minimal visible image size and an available area on the display screen surrounding the window. The snapshot images may be displayed for a user to identify the separate presentations over the area arranged in a two dimensional grid encompassed by the surrounding area of the window.

In yet another embodiment for switching presentations for a window, a plurality of tabs may be presented in a tab bar of the window. Each tab may correspond to one of the presentations. A dragging operation on the tabs may be detected to present a plurality of thumbnails on top of the window in a display screen. Each thumbnail may correspond to one of the tabs. When a clicking operation or other selection operation on a particular thumbnail is detected, the window may be updated to provide an interface for a particular task or presentation corresponding to the particular thumbnail.

In certain embodiments of the present invention, multiple modes may be provided for presenting tabs with images which are rich in visual information to improve tab navigation. Each mode can correspond to an alternative way to present tabs. In a drop down mode, tabs can be dropped down into thumbnail like images arranged as a cover flow view or in other formats. In an exposé mode, a tab bar including tabs aligned along a single dimension can be exploded into a two dimensional grid of images in thumbnail view. An area including significant amount of extra screen real estate in addition to a target window with tabs can be utilized to enhance presentations of the tabs as thumbnail like images without losing a solid connection to the target window. Smooth transitions between tabs presented in different modes can be provided via animation while reinforcing the correspondence between thumbnail like images and the tabs. Additionally, a tab can be dragged around as a mini-window image before turning into a window.

Other features and embodiments are described further below. It will be understood that the present invention may be implemented in a variety of data processing systems, such as general purpose computers, handheld computers, embedded systems, cellular telephones, and other consumer electronic devices. It will also be understood that the present invention may be implemented in software which is stored on a computer readable medium which will cause a data processing system to perform one or more of the methods described herein.

### BRIEF DESCRIPTION OF THE DRAWINGS

The present invention is illustrated by way of example and not limitation in the figures of the accompanying drawings in which like references indicate similar elements and in which:

FIG. 1 shows an example of a user interface including a tab bar in a window having a plurality of labeled tabs;

FIG. 2 shows an example of a user interface including a tab bar in a window having a plurality of thumbnail tabs in a drop down mode;

FIG. 3 shows an example of a user interface including an ordered grid of snapshot images presented over a window in a tab exposé mode;

FIG. 4 shows an example of a user interface including a new window generated from a tab dragged out of a tab bar;

FIG. 5 is a block diagram illustrating one embodiment of a system to manage tabs for switching among different presentations;

FIG. 6 is a flow diagram illustrating one embodiment of a process to expand a tab bar for displaying thumbnail tabs;

FIG. 7 is a flow diagram illustrating one embodiment of a process to present snapshot images in a grid view;

FIG. 8 is a flow diagram illustrating one embodiment of a process to create a window according to a tab dragged out of an existing window;

FIGS. 9A-9C show an example, through screen shots, of a user interface in which a tab bar in a window is expandable to display thumbnail tabs as snapshot images;

FIGS. 10A-10C show an example, through screen shots, of a user interface in which all the tabs in a window are exposed as snapshot images;

FIGS. 11A-11D show an example, through screen shots, of a user interface for dragging a tab out of a tab bar to generate a new window;

FIGS. 12 shows an example of a data processing system which may be used to implement any one of the embodiments described herein.

### DETAILED DESCRIPTION

The subject invention will be described with reference to numerous details set forth below, and the accompanying drawings will illustrate the invention. The following description and drawings are illustrative of the invention and are not to be construed as limiting the invention. Numerous specific details are described to provide a thorough understanding of the present invention. However, in certain instances, well known or conventional details are not described in order to not unnecessarily obscure the present invention in detail.

The present description includes material protected by copyrights, such as illustrations of graphical user interface images. The owners of the copyrights, including the assignee of the present invention, hereby reserve their rights, including copyright, in these materials. The copyright owner has no objection to the facsimile reproduction by anyone of the patent document or the patent disclosure, as it appears in the Patent and Trademark Office file or records, but otherwise reserves all copyrights whatsoever. Copyright Apple Inc. 2009.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The present invention will be described relative to the Macintosh Operating System (OS). It will be understood that one or more embodiments described herein may also be employed in other operating systems or in other software products, such as the Windows operating system or a mobile device operating system (e.g. an operating system for a smart phone or other cellular telephone.)

In one embodiment, tabs may be presented with visually rich images such as thumbnails to facilitate tab switching for a window. A thumbnail representing a tab may be generated from a snapshot of the window which provides interface for a presentation associated with the tab. A user can drag on the bottom edge of a tab bar including tabs in a default view (or presented in a traditional manner) to expand the tab bar for displaying thumbnail like images for the tabs arranged in a horizontal flow, similar to, for example an Apple TV-style cover flow. A user can drag an expanded tab bar (e.g. in expanded view) back into a collapsed view or a default view. A tab bar may be collapsed by default. A user can also expand a default tab bar by dragging on a draggable part of the default tab bar, e.g. a dot on the left end of the tab bar.

In one embodiment, when a mouse is near a draggable area, such as the bottom edge or a left dot of a default tab bar, the cursor may change (e.g. in shape, color and/or size etc.) to indicate interactivity. As the tab bar expands, tabs may morph into thumbnail like images and the tab bar may morph into a coverflow (or an expanded tab bar) that displays front-facing thumbnail like images. The cover flow may center on a selected tab. Front-facing thumbnail like images may include visible titles for easy skimming. In one embodiment, the bottom of a default tab bar may turn into a scrollbar for navigating through the cover flow. A user can navigate an expanded tab bar by using a scrollbar, a mouse wheel, or by clicking directly on the thumbnail like images. Using the scrollbar or the mouse wheel may move the thumbnail like images without changing the current tab selection.

In one embodiment, a thumbnail like image or a thumbnail tab for the selected tab may include a selection background to indicate the current selection. When the thumbnail tab of the current selection scrolls off to the side, the selection background may shrink accordingly, but may still be visible for a user to click on it to center a cover flow on the selected thumbnail tab. A thumbnail tab may be displayed in a slanted manner on either side of a cover flow. When a thumbnail tab is clicked on, whether front-facing or slanted, a cover flow may center on the clicked-on thumbnail tab and select it. Existing keyboard shortcuts for going to the previous and next tabs may function in a similar way, along with corresponding animation of a cover flow. Activating a thumbnail tab, e.g. via a hot-key, may cause an area above and around the thumbnail tab to darken considerably.

In one embodiment, tab operations, such as closing, dragging, and opening tabs, may be available in an expanded or collapsed tab bar to keep the tab bar expanded. A thumbnail tab may be closed via close button appearing on mouse over. In one embodiment, a button may reside on the top right of a cover flow for opening new tabs. When clicked, the button may create and select a new tab at the end of the cover flow. The button may open a new tab according to a location where a plus button opens a new tab in the default tab mode. For example, if a new tab is opened in the middle of a tab list in the default tab mode, a new tab may be opened in the middle of a tab list for the cover flow. In one embodiment, a user can rearrange tabs by dragging a front-facing thumbnail tab to cause a cover flow to scroll accordingly either by a mouse wheel or by dragging the tab toward slanted thumbnail tabs on the left or right side of the cover flow.

At least certain embodiments of the present invention provide an ordered grid view of thumbnail like images to present tabs in a two-dimensional manner, e.g. in a tab exposé view, to support presentation switching in a window, such as a Safari® window for a browser application. In one embodiment, a thumbnail like image may include a text label, e.g. contained in a small semi-transparent pill at the bottom of the image. Visually, the window and a surrounding area may be significantly darkened in the tab exposé view. Thumbnail like images may be displayed on top of the darkened area to represent all of the window's tabs. The darkened area may include extra screen real estate in addition to the area of the window. Actual amount of the extra screen real estate may be adjusted automatically based on the screen size, the number of tabs in the tab expose, and/or available screen real estate.

A simple mapping between a two-dimensional grid in a tab exposé and a one-dimensional tab bar may be animated to reveal an ordered transition. In one embodiment, a selected tab or thumbnail tab (e.g. a rectangular snapshot) may zoom up to fill content area of a window while the rest of a tab exposé view or grid view may either animate back into place or fade away. A tab exposé may be activated via a menu-item, e.g. “Show All Tabs”, in a window menu associated with a hot-key, e.g. Command+Shift+T. Other activation mechanisms may be possible including, for example, mouse or trackpad gestures, a dedicated mouse button, screen hot corners, or a button in a tab bar. Typically, a tab exposé may not take over the entire screen. System windows, such as a Finder window for object search, may remain mostly unobscured during tabs operation. A system window may immediately dismiss a tab exposé when activated (e.g. clicked on). In one embodiment, if a window is in a full screen mode or a maximized mode, a corresponding tab exposé may take over the full screen.

A tab exposé in a grid may appear in a quick animation starting with the first thumbnail in the top-left part of the grid, and proceeding in a left-to-right order, wrapping from the end of one line to the beginning of the next. The timing of the animations may be such that the entire animation for all the tabs be complete in a certain amount of time, which may vary depending on the total number of tabs present, up to a maximum amount of time. The first item, e.g. top left item, in the grid may represent the first item, e.g. leftmost item, in the tab bar. Subsequent tabs may be ordered, e.g. left-to-right, wrapping as needed. The last item, e.g. bottom right item, in the grid may represent the last item, e.g. rightmost item, in the tab bar. A mouse hovering over a thumbnail like image may cause a thumbnail like image to be highlighted (e.g. selected), which may be represented by a noticeable glow or outline around the image. Arrow keys can also be used to change selection. Once a thumbnail like image is chosen, either by a mouse click or the keyboard, another quick animation may occur to duplicate a corresponding window.

In one embodiment, dragging a thumbnail tab or thumbnail like image out from a cover flow or a tab exposé may cause a similar behavior as in dragging a tab out of a collapsed tab bar. For example, a thumbnail tab may morph into a window preview, which may be a mini window based on a snapshot of a window performing a presentation corresponding to the thumbnail tab. Dropping a dragged-out tab, e.g. represented by a mini window, may cause a new window to be created outside of an original window for the tab.

According to one embodiment, tabs may be presented in different modes, e.g. a regular mode, a drop down mode or an exposé mode for ease of rearranging the tabs. For example, a two dimensional grid in an exposé mode may allow two dimensional movements for tabs to change relative positions or change a two dimensional order among the tabs within the grid, such as based on a modifier key and/or a drag and drop operations via a mouse. In one embodiment, changes of relative positions or order among tabs in one mode, e.g. an exposé mode, may be synchronized automatically to other modes, e.g. causing an reorder of the tabs in a regular mode and/or an expanded mode.

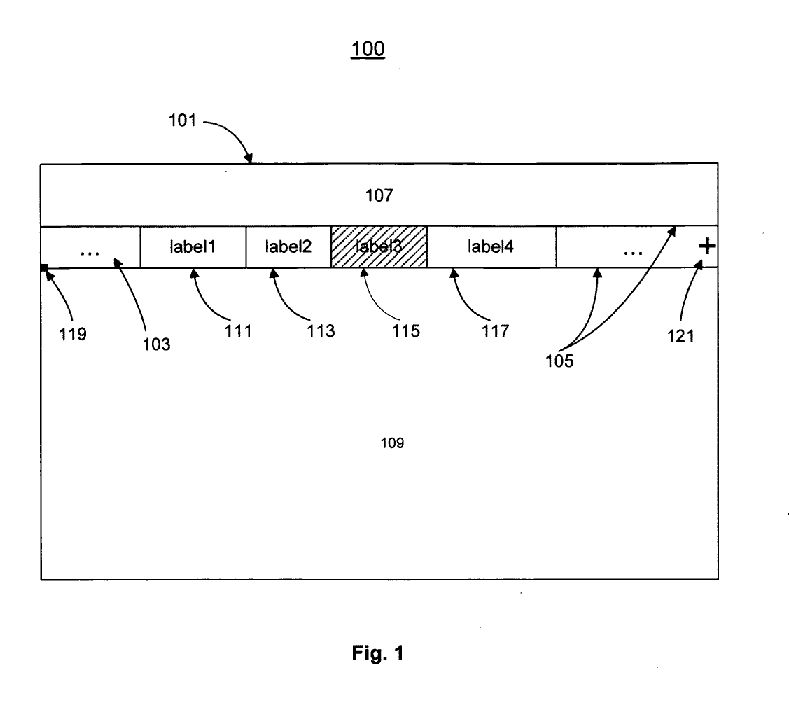

FIG. 1 shows an example of a user interface including a tab bar in a window having a plurality of labeled tabs for switching among separate presentations using the window. Interface 100 may include a window 101 associated with a plurality presentations. It will be understood that a window may be a display region on a display screen of a display device coupled to a data processing system, such as a desk top computer. In one embodiment, the display region has a defined border or perimeter and can be moved independently of other display regions on a desktop region and can be minimized.

The plurality of presentations associated with window 101 may be performed by different applications or a single application running in the data processing system coupled to the display device. For example, a browser application associated with a window may open several documents, each document opened may correspond to a separate presentation for the window. In another embodiment, multiple instances of a terminal emulation application may use a single window to interface with a user. Each instance of the terminal emulation application may be a separate presentation for the window.

In one embodiment, window 101 can include a tab bar 103 having tabs for switching among separate presentations corresponding to the tabs in the tab bar. In one embodiment, a tab can include a label, e.g. a text or a title, indicating the corresponding presentation, such as “label1” in tab 111. A tab may be a user interface control allowing a system to detect user interface actions, such as clicking, selecting, dragging and/or dropping, for example, via an input device such as a mouse guided by a cursor hovering over the tab on a display screen. When clicked, a tab can cause window 101 to provide interface functions, for example, in workspaces 107, 109, for a presentation corresponding the tab clicked (or selected) as the current presentation. In some embodiments, a tab in a tab bar may be highlighted or marked to indicate a currently selected presentation for a window, such as tab 115 for current presentation “label3” using window 101.

Tab bar 103 may include other user interface controls such as top and bottom edges 105 and dot 119 which can be moved by dragging. In some embodiments, a tab bar may automatically add a scrollbar to scroll tabs along the tab bar if there is not enough space available on the tab bar to display all the tabs. The tab bar may include other indicators, such as “>>”, “>”, “<<”, “<”, etc., to indicate existence of additional tabs in the tab bar. In some embodiments, a list of all the tabs may be displayed in a menu style when “>>” is clicked. In one embodiment, tabs in the tab bar may be displayed in an array having an order, e.g. from left to right according to time of creation. A user may drag and drop a tab from/to a tab bar for rearranging the order of the tabs in the tab bar. When a tab in a tab bar is clicked or selected to switch a window to a presentation associated with the tab, tabs in the tab bar may be repositioned to indicate the selection of the presentation, e.g. shifted left or right to place the selected tab in the middle portion of the tab bar. In one embodiment, the last tab (e.g. containing an indicator “>>”) may be pushed off into a menu (e.g. a cover flow menu), and a selected tab may appear in its place (e.g. also containing the indicator “>>”). Button 121 in tab bar 103 may allow new tabs to be created and opened. A close button may appear when a mouse hovering over a tab to allow closing the tab.

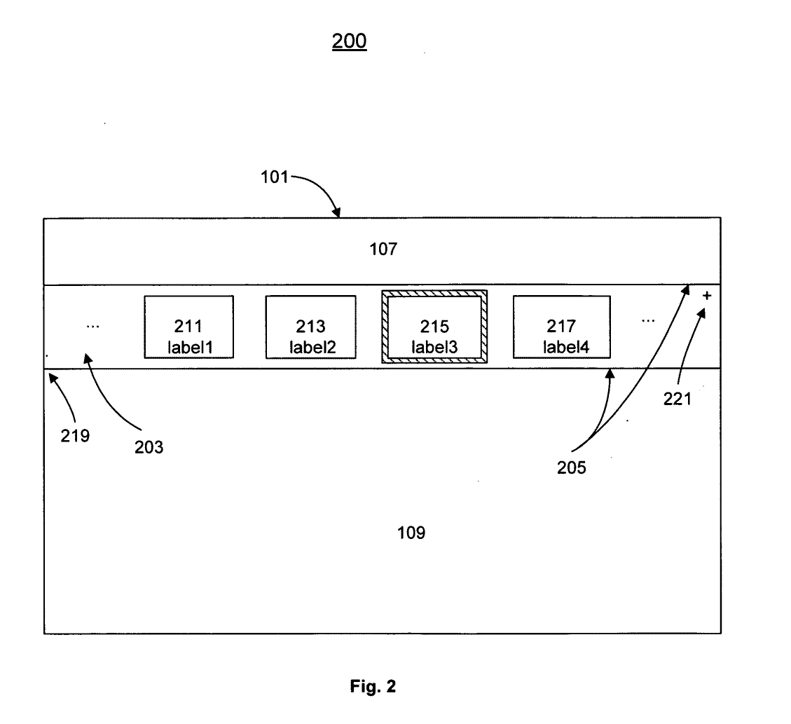

FIG. 2 shows an example of a user interface including a tab bar in a window having a plurality of thumbnail tabs in a drop down mode. Tab bar 203 may be presented in a drop down mode as an alternative view, e.g. an expanded view, of tab bar 103 of FIG. 1 for providing richer visual information to represent a presentation associated with each tab. Tabs 211, 213, 214 and 217 in an expanded view may correspond to tabs 111, 113, 115 and 117 of FIG. 1 in a collapsed view. A tab displaying only a label to indicate an associated presentation for a window, such as tabs 111, 113, 115, 117 of FIG. 1, may be in a collapsed view. In one embodiment, a tab in an expanded view, such as tab 211, may share indicators presented in a corresponding tab in a collapsed view, such as the label “label1” of tab 111 of FIG. 1. A tab may include user interface functions independent of whether presented in an expanded view or a collapsed view.

In one embodiment, a tab in an expanded view may be presented as a thumbnail tab including a thumbnail generated from a snapshot image of a corresponding presentation using a window. The snapshot image may represent a live view of the window providing interface functions for the presentation when the thumbnail is generated. For example, a snapshot image may be taken from a live view of a browser navigating to a document located via an URL (Universal Resource Locator). In one embodiment, a thumbnail may include a snapshot image reduced in size, such as according to a dimension (width or height) of a tab bar in an expanded view.

In one embodiment, thumbnails for all tabs in a tab bar may be generated regardless whether there is enough real estate inside an expanded tab bar to display each thumbnail tab front-facing without overlapping with each other. One or more thumbnail tabs may be displayed in a slanted manner to indicate existence of additional tabs in a tab bar. A thumbnail tab may be highlighted or marked with selection background as currently selected thumbnail tab, such as tab 215 corresponding to tab 115 of FIG. 1. In one embodiment, the currently selected thumbnail tab may be front-facing centered in the cover flow for the expanded tab bar. Button 221 in tab bar 203 may allow new thumbnail tabs to be created and opened.

In one embodiment, a dragging operation can be detected via edges 105 or dot 119 to expand tab bar 103 of FIG. 1 from a collapsed view into tab bar 203 in an expanded view. Similarly, tab bar 203 may be collapsed into tab bar 103 of FIG. 1 by dragging edges 205 or dot 219 of tab bar 203. In one embodiment, when a cursor is near a draggable area, such as edges 205 and/or dot 219, the cursor may change to a resize cursor to indicate interactivity. Expanding or collapsing a tab bar may include animation of morphing titles to or from thumbnail tabs. In one embodiment, the animation may include morphing a bottom edge of the tab bar, such as edge 105, into a scrollbar for navigation in a cover flow. When tab bar 103 of FIG. 1 is expanded to tab bar 203, sizes of workspaces 107, 109 of window 101 may be adjusted to provide display space for the expanded tab bar.

In one embodiment, tab bar 203 in an expanded view (or an expanded tab bar) may allow scrolling via a scrollbar, direct scrolling (e.g. dragging a front-facing tab), and/or a mouse wheel. Navigating tab bar 203 using a scrollbar or a mouse wheel may move tabs in the tab bar without changing tab selection, thus maintaining the current presentation in window 101. When a selected tab marked with selection background scrolls off to the side, in one embodiment, the selection background may shrink accordingly, but still be visible to allow clicking on the selected tab. In one embodiment, when a thumbnail tab is clicked, regardless whether it is displayed front facing or slanted in the cover flow of tabs in a tab bar, the cover flow may automatically scroll (e.g. with animated horizontal shifting) the tabs to center the thumbnail tab clicked-on and mark it as selected.

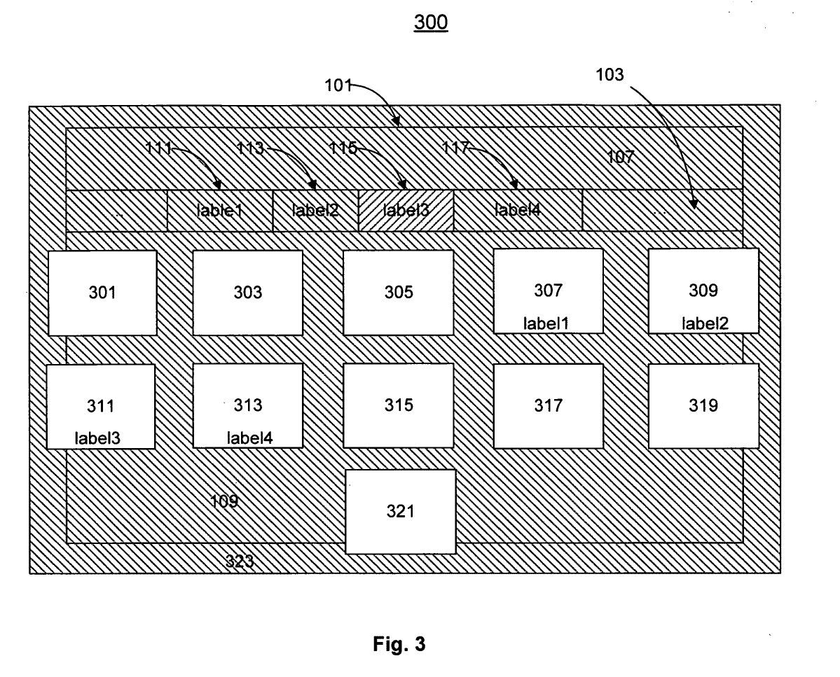

FIG. 3 shows an example of a user interface including an ordered grid of snapshot images presented over a window to represent thumbnail tabs in a tab exposé mode. A tab bar in a compressed mode, e.g. tab bar 103, or a pull down mode, e.g. tab bar 203 of FIG. 2, may be changed to an exposé mode via a window menu item, a keyboard hot key, a mouse or track pad gesture, a mouse button, a screen hot corner, a button in the tab and/or other activation mechanisms.

In one embodiment, tab exposé mode can display tabs as snapshot images over a display area larger than a tab bar in a window for easier tab identification and more efficient tab navigation to switch presentations in the window. The display area may be allocated based on the window plus an extra amount of screen real estate without taking over the entire screen. For example, all tabs in window 101 may be presented as snapshot images 301, 303 . . . 321 over display area 323 covering window 101. The extra amount of screen real estate used in addition to the window in the tab exposé mode may be dynamically determined considering, for example, the entire screen size, the window size, and/or the number of tabs opened in a system, etc. Other factors may apply. In one embodiment, the exposé mode may significantly darken the window and a surrounding area in the display area to display the snapshot images for the tabs over the darkened area, e.g. area 323. Portions of the display screen other than the display area may remain obscured to allow activation of other applications, e.g. a system finder, and to dismiss the exposé mode.

Snapshot images 301, 303 . . . 321 may be arranged in an ordered grid view, for example, according to an order of tabs in tab bar 103. The top left item 301 in the grid may represent the leftmost tab in tab bar 103. Subsequent tabs in tab bar 103 may be ordered left to right and top to bottom, wrapped as needed, within display area 323. Snapshot images 307, 309 . . . 313 in the grid may correspond to tabs 111, 113 . . . 117 in tab bar 103. For example, snapshot image 307 may be an image resized (or of the same size) from thumbnail image 211. The bottom right item 321 may represent the rightmost tab in tab bar 103. Other arrangements of items in a grid, such as left right, left aligned, right aligned, etc are possible.

Similar to a thumbnail tab, each snapshot image of a window may be a simple rectangular image including a snapshot (reduced in size) of a corresponding live presentation using the window. The snapshot image may include a semi-transparent pill displaying a text label beneath the snapshot, e.g. label “label1” in item 307. A snapshot image in a grid may include the same label as displayed in a corresponding tab in a tab bar, e.g. as shown in item 307 and tab 111. A snapshot image may be based on a corresponding thumbnail tab resized from an expanded tab bar (e.g. cover flow).

In one embodiment, animation may be activated, e.g. via an option setting for the window, to transition presentation of tabs in a tab bar of window between different modes, such as a compressed mode, a pull down mode or an exposé mode. When animation is activated, presenting tabs in an exposé mode may appear in a quick animation. The animation may ease transitions between different modes and reinforce that snapshot images that appear represent the tabs. An animation to present tabs as snapshot images in an exposé mode may include, for example (e.g. starting substantially simultaneously):
a radial gradient to darken a portion of the screen, e.g. display area 323, for snapshot images to fade in;
content areas of a window, e.g. areas 107, 109, may shrink down into an appropriate location in a corresponding selected tab, e.g. tab 115, while leaving behind either a darkened version of the content area or a different static image;
individual snapshot images for each tab may begin to animate in. The timing of these animations may depend on the total number of tabs:
   if the total number is small, for example, no greater than a preset threshold value (e.g. 4), the snapshot images may appear in sequence, e.g. 1^{st}, 2^{nd}, 3^{rd}, and 4^{th} . . . , in their correct spots, e.g. as assigned in a grid within a display area. The snapshot images may have a quick fade-in animation to make the transition more visually appealing;
   if the total number is large, for example, greater than the preset threshold number, then the first threshold number (e.g. 4) of snapshot images may appear in sequence followed by simultaneous showing of the rest of the snapshot images. Alternatively, the snapshot images may appear in an ordered fashion, with a slight delay between them. For example, the first snapshot image may appear in the top-left part of the grid, and proceed in a left-to-right order, wrapping from the end of one line to the beginning of the next. The timing of the animations may be constrained to allow completing the entire animation of all the snapshot images within a certain amount of time. This total amount of time may vary depending on the total number of tabs present, up to a maximum amount of time. The total animation duration can be divided up evenly among the snapshot images, or according to a curve that gives a larger amount of time to the first few snapshot images. This animation and timing may reveal a simple mapping between a two-dimensional grid and one-dimensional tab bar to a user.

In one embodiment, a cursor hovering over a snapshot image in an exposé mode may identify the snapshot image for selection. A special key, such as arrow key, in a keyboard may allow a user to select different snapshot images for selection. An identified snapshot image may be represented by a noticeable glow or outline around the snapshot image. In one embodiment, an identified snapshot image may be selected, for example, via a mouse click or a keyboard press. Once a snapshot image for a window is selected from a grid in an exposé mode, the selected snapshot image may zoom up to fill content area of the window, such as areas 109, 107 of window 101, while the rest of the grid may animate back into place in a tab bar (e.g. as tabs in a default tab bar or thumbnail images in an expanded tab bar) of the window or simply fade away. In the meanwhile, the darkened area in the exposé mode may light back up, e.g. in an animated fashion, for a pull down mode or a compressed mode. One snapshot image may be highlighted or marked as selected in the tab bar in the pull down or compressed mode. The animation may include scrolling the tab bar to center the selected snapshot image. In one embodiment, animating snapshot images in a grid back to a tab bar may indicate an order to arrange the tabs in the tab bar.

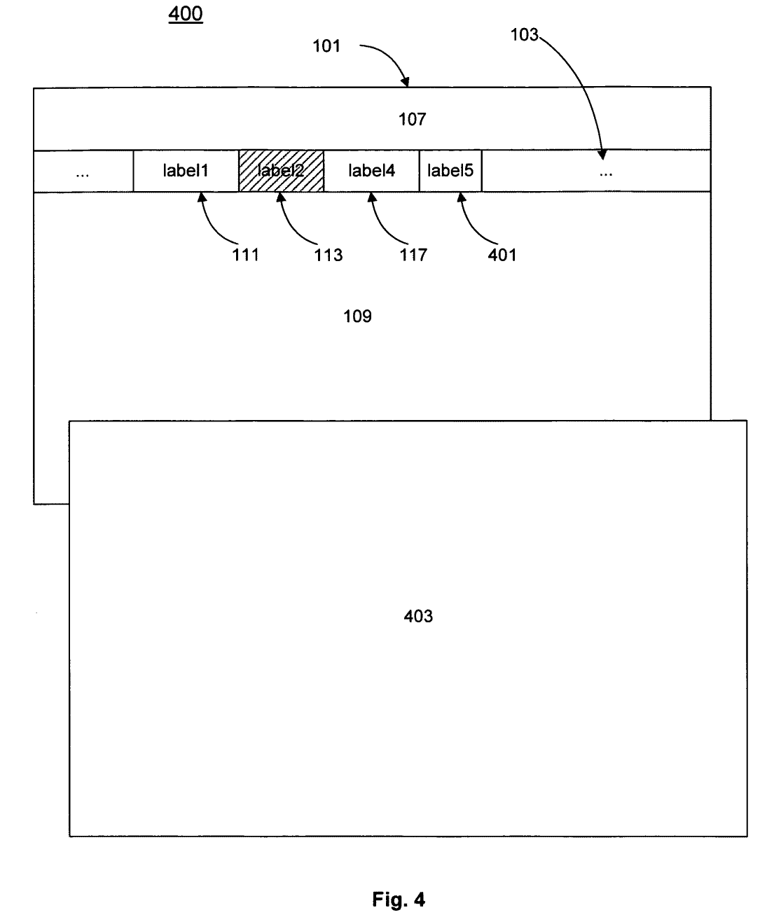

FIG. 4 shows an example of a user interface including a new window generated from a tab dragged out of a tab bar for a presentation associated with the tab. For example, window 403 may provide an interface for a presentation corresponding to tab 115 of FIG. 1. In one embodiment, window 403 may include similar user interface components (e.g. frames, buttons, or other controls) and/or have similar dimensions to those of window 101 in FIG. 1 when tab 115 is selected. Tab bar 103 may include all the tabs of window 101 in FIG. 1 except tab 115. In one embodiment, tab 401 may be ordered next to tab 117 in tab bar 103 of FIG. 1.

In some embodiments, if a tab is dragged out of a tab bar in a window to a location outside of the window on a display screen, the tab may be morphed into a window preview, such as a resized snapshot of a live interface to a corresponding presentation using the window. Dragging out a thumbnail tab from a cover flow or an expanded tab bar may behave the same as or similar to dragging out a tab from a collapsed tab bar. The window preview may track the location, for example, according to the movement of a cursor via a mouse. In one embodiment, when a tab is dropped at a destination location, e.g. via releasing a mouse button while the cursor is pointed at the destination location, a window preview may grow into a new window (e.g. including content of the window preview) at the destination location to provide interface for a presentation corresponding to the tab. An animation may indicate the tab morphing from the tab bar into the new window while the original window, from which the tab is dragged, is being updated, for example, including removing the tab from the tab bar and/or selecting the next tab in order in the tab bar.

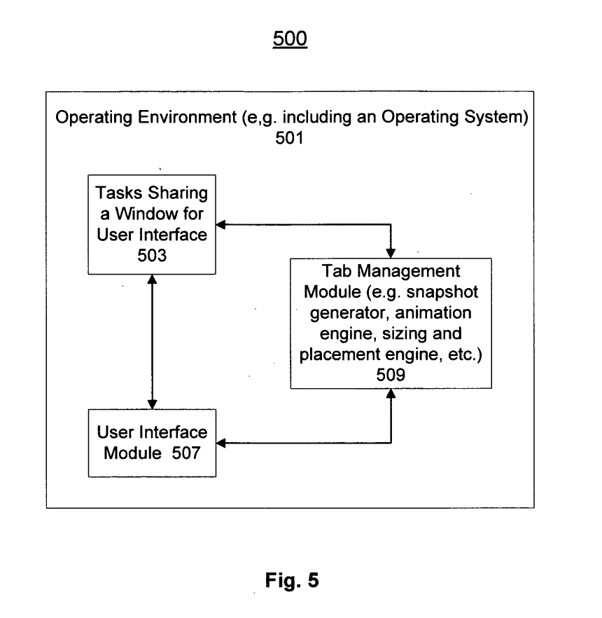

FIG. 5 is a block diagram illustrating one embodiment of a system to manage tabs for switching among different presentations for a window. In one embodiment, system 500 can include an operating environment (e.g. a computer operating system) 501 that supports one or more applications (or application processes) to perform one or more presentations 503 sharing a single window, such as window 101 in FIG. 1, displayed on display device via user interface module 507. Additionally, user interface module 507 may detect and manage user actions, such as clicking, dragging, dropping and/or other actions on user interface elements displayed. The window may display interface elements (e.g. user interface controls) and/or contents for one of the presentations (e.g. as a currently selected presentation), while other presentations may be performed in the background or waiting to be activated in system 501. In one embodiment, separate presentations may be performed by one application. For example, two different presentations may correspond to two different documents opened by a single browser application or word document application. In another embodiment, different presentations may be performed by separate applications running concurrently in system 501.

A window, such as window 101 of FIG. 1, shared by presentations 503 may include tabs in a tab bar, such as tab bar 103 of FIG. 1, managed via tab management module 509. In one embodiment, tab management module can maintain an association between each tab in the window with one of presentations 503. Tab management module 509 may include a snapshot generator module which can dynamically generate a snapshot from current rendering data for a presentation associated with a tab using the window. In one embodiment, the snapshot generator may activate a presentation to produce live rendering information. The snapshot generator may retrieve a previously generated snapshot stored for a presentation if the stored snapshot is not obsolete (e.g. based on a time stamp and a maximum age of the stored snapshot).

Tab management module 509 may include a sizing and placement engine which could determine the size for an image updated from a snapshot generated for a presentation. For example, the image may appear as a thumbnail tab in an expanded tab bar, such as tab 211 of FIG. 2 or as a snapshot image in an exposé mode, such as tab 307 of FIG. 3. The sizing and placement engine may determine a display area larger than a window, such as display area 323 over window 101 in FIG. 3 to present tabs in an exposé mode. In one embodiment, tab management module 509 may include an animation engine to create visual effects for animating transitions between a collapsed tab bar, e.g. tab bar 103 of FIG. 1, an expanded tab bar, e.g. tab bar 203 of FIG. 2, and tabs in an exposé mode, e.g. tabs 301, 303 . . . 321 of FIG. 3. The animation engine may morph a tab dragged out from a tab bar for a new window providing interface for a presentation associated with the tab, such as window 403 in FIG. 4 generated from tab 115 dragged out from tab bar 103 of FIG. 3.

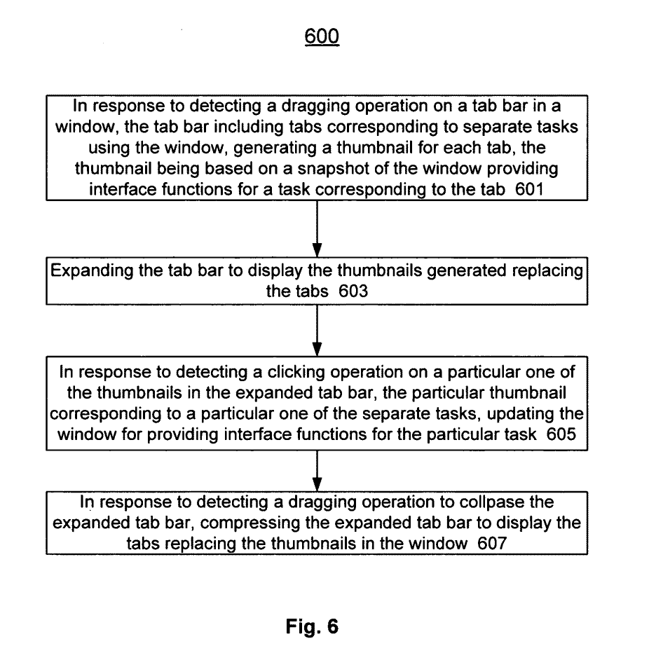

FIG. 6 is a flow diagram illustrating one embodiment of a process to expand a tab bar for displaying thumbnail tabs in a window. Exemplary process 600 may be performed by a processing logic that may comprise hardware (circuitry, dedicated logic, etc.), software (such as is run on a dedicated machine), or a combination of both. For example, process 600 may be performed by some components of system 500 of FIG. 5. The processing logic of process 600 can generate thumbnails to present tabs in an expanded tab bar, such as tab bar 207 of FIG. 2 in window 101 of FIG. 1, when detecting a user interface operation to expand a collapsed tab bar, such as tab bar 103 of FIG. 1, to the expanded tab bar. The user interface operation may include keyboard actions, mouse actions, direct touch screen actions, or other applicable user interface actions. For example, a user may use a mouse to click on a user interface control associated with a collapsed tab bar, such as button 119 or edges 105 of tab bar 103 of FIG. 1, to select and drag the bottom to cause dragging operation on the collapsed tab bar. Keyboard shortcuts on a window, such as window 101 of FIG. 1, including a collapsed tab bar may cause similar user interface operations.

The processing logic of process 600 can generate a snapshot or retrieve a previously stored snapshot from a window which provides user interface functions for a presentation. Each generated snapshot may be a live or near live snapshot of a presentation using the window. A near live snapshot may be a previously stored snapshot having a time stamp within a certain age, e.g. from the time when a dragging operation is detected. A thumbnail may be an image resized from a snapshot. For example, the processing logic of process 600 may resize a snapshot for a thumbnail tab according to a dimension of an expanded tab bar to present a tab in a cover flow, such as tab bar 207 of FIG. 2.

At block 603, the processing logic of process 600 can expand a collapsed tab bar to display thumbnail tabs as an expanded tab bar. A thumbnail tab may include a generated thumbnail and a text label, such as tab 211 of FIG. 2. In one embodiment, the processing logic of process 600 can generate animation visual effects to morph tabs in a collapsed tab bar, such as tabs in tab bar 103 of FIG. 1, onto thumbnail tabs in an expanded tab bar, such as tabs in tab bar 207 of FIG. 2.

In one embodiment, at block 605, the processing logic of process 600 may detect (or receive) a clicking operation on a thumbnail tab of an expanded tab bar, for example, via mouse or keyboard actions while a cursor hovering over the thumbnail tab. In response, the processing logic of process 600 can update the window to provide interface functions for a presentation corresponding to the thumbnail tab clicked. For example, a particular thumbnail tab clicked may correspond to a document for a browser application using the window. The processing logic of process 600 can highlight the thumbnail tab clicked on to indicate a currently selected tab, such as tab 215 of FIG. 2.

At block 607, according to one embodiment, the processing logic of process can detect a user interface operation to collapse an expanded tab bar, such as tab bar 207 of FIG. 2. For example, a user interface operation may include dragging a user interface control associated with an expanded tab bar, such as button 219 or edges 205 (e.g. including a draggable scrollbar) of tab bar 207 of FIG. 2. In response, the processing logic of process 600 can morph thumbnails tabs in an expanded tab bar, such as tab bar 203 of FIG. 2, to tabs with text labels in a collapsed tab bar, such as tab bar 103 of FIG. 1.

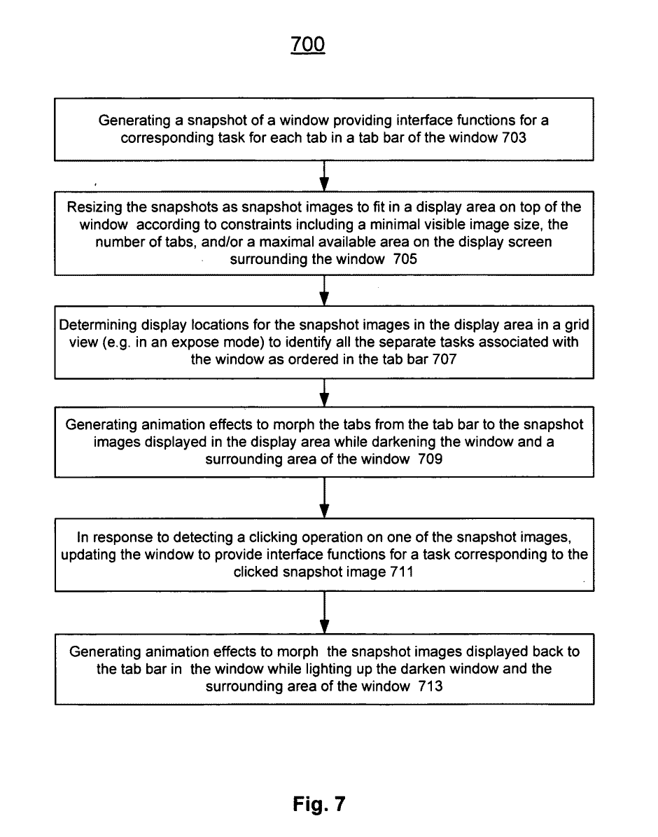

FIG. 7 is a flow diagram illustrating one embodiment of a process to present snapshot images to identify presentations using a window in a grid view. Exemplary process 700 may be performed by a processing logic that may comprise hardware (circuitry, dedicated logic, etc.), software (such as is run on a dedicated machine), or a combination of both. For example, process 700 may be performed by some components of system 500 of FIG. 5. At block 703, the processing logic of process 700 may generate, for each tab in a tab bar, e.g. a default tab bar or an expanded tab bar, of the window, a snapshot of the window providing interface functions for the corresponding presentation which is running at the time the snapshot is taken. The processing logic of process 700 may receive a user command, e.g. via a window menu or a keyboard hot-key to generate snapshots for the tabs of the tab bar. At block 705, the processing logic of process 700 may resize each snapshot as snapshot image to display all the snapshot images in a display area on top of the window, e.g. covering at least a center portion of the window such as snapshot images 301, 303 . . . 321 of FIG. 3. In some embodiments, the processing logic of process 700 may generate a snapshot image based on thumbnail images (e.g. resized) representing tabs in an expanded tab bar.

The processing logic of process 700 may determine the display area according to a plurality of constraints, such as a minimal visible image size, the number of tabs (each corresponding to a snapshot image), an available area surrounding the window on the display screen, and/or other sizing constraints. The constraints may allow each snapshot image to be displayed in a maximum snapshot image size if the window is of a size larger than a maximal size determined by the maximum snapshot image size and the total number of tabs in the tab bar. For example, the maximal size may be obtained as (the maximum snapshot image size+spacing parameter)*the total number of tabs. The display area may be encompassed by the available area.

In one embodiment, the minimal visible image size may be preset depending on screen resolution of the display screen. An available area surrounding a window may be dynamically determined according to the dimension and location of the window. For example, the larger the portion of the screen the window occupies, the less the area surrounding the window may be available. Some regions of the display screen may not be available for the display area. For example, system windows providing system application, such as file folder, document finder, job control, etc. may be prohibited from being obstructed by the display area for an exposé mode. In one embodiment, a single size may be selected for all the snapshot images for the tabs. The processing logic of process 700 may assign a maximal size as one of the constraints for displaying the snapshot images.

At block 707, the processing logic of process 700 may determine display locations for snapshot images in a display area, such as area 323 of FIG. 3, in a grid view (e.g. in an exposé mode) to identify all presentations associated with a window. In one embodiment, the snapshot images can be ordered (e.g. left right, top down) in accordance with an order of corresponding tabs displayed in a tab bar of the window. The display area with more screen real estate than a tab bar may allow better presentation of the presentations associated with a window via richer visual information in each snapshot image than a tab in the tab bar.

In one embodiment, at block 709, the processing logic of process 700 can generate animation effects to morph tabs from a tab bar (e.g. thumbnail images from an expanded tab) in a window to snapshot images displayed in a display area on top of the window. The processing logic of process 700 may darken the window and a surrounding area, such an area substantially correspond to area 323 of FIG. 3, to allow the snapshot images better contrast for presentation. The animation effects can include a sequence to morph tabs from the tab bar into snapshot images in the display area consistent with how the tabs are ordered in the tab bar.

At block 711, according to one embodiment, the processing logic of process 700 may detect a clicking operation on a snapshot image displayed in an exposé mode on top of a darkened window, such as snapshot image 307 on top of window 101 of FIG. 3. The clicking operation may indicate a user selection of the snapshot image using keyboard or mouse devices. In response, the processing logic of process 700 may update the window to provide interface functions for a presentation corresponding to the clicked snapshot image. At block 713, the processing logic of process 700 may generate animation effects to morph the snapshot images displayed in a grid view on top of the darkened window back to a tab bar while lighting up the darkened window and the surrounding area, such as area 323 of FIG. 3. The processing logic of process 700 may clear or fade away the snapshot images from the display area. In one embodiment, the processing logic of process 700 can morph a snapshot image back to a tab in the tab bar.

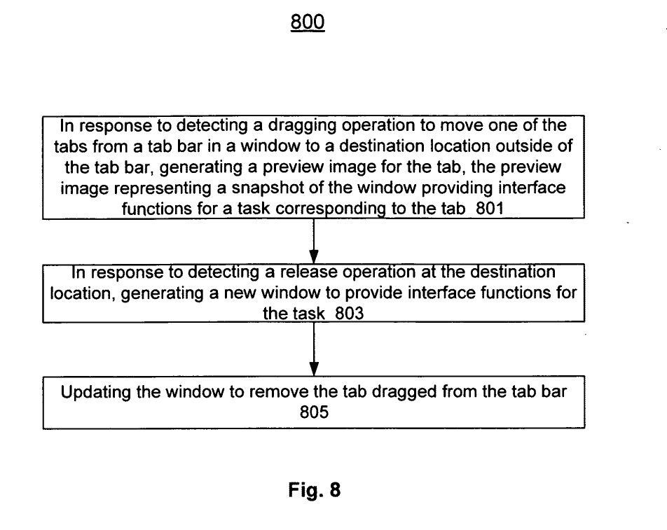

FIG. 8 is a flow diagram illustrating one embodiment of a process to create a window associated with a presentation according to a tab dragged out of an existing window. Exemplary process 800 may be performed by a processing logic that may comprise hardware (circuitry, dedicated logic, etc.), software (such as is run on a dedicated machine), or a combination of both. For example, process 800 may be performed by some components of system 500 of FIG. 5. At block 801, the processing logic of process 800 may detect a dragging operation to move a tab from a tab bar in a window to a destination location outside of the tab bar on a display screen. In response, the processing logic of process 800 can generate a preview image representing a snapshot of the window providing interface functions for a presentation corresponding to the tab. In one embodiment, the preview image may be a reduced image of the snapshot.

At block 803, the processing logic of process 800 may detect a release operation, e.g. based on a mouse button release signal during a dragging operation of a tab from a window, at the destination location while presenting a preview image for a presentation corresponding to the tab near or at the destination location. In response, the processing logic of process 800 can generate a new window, e.g. window 403 of FIG. 4, in place of the preview image to provide interface functions for the presentation. In one embodiment the newly generated window, e.g. window 403 of FIG. 4, may be based on a copy of the source window the tab is dragged from, e.g. window 101 of FIG. 4.

At block 805, the processing logic of process 800 may update the source window to remove the tab from a tab bar, such as tab bar 103 of FIG. 4. If the tab dragged out is a currently selected tab in the source window, a next tab in order as displayed in the tab bar may be automatically selected (e.g. highlighted) to update workspace, such as workspace 107, 109 of FIG. 4, of the source window according to a corresponding presentation for the newly selected tab.

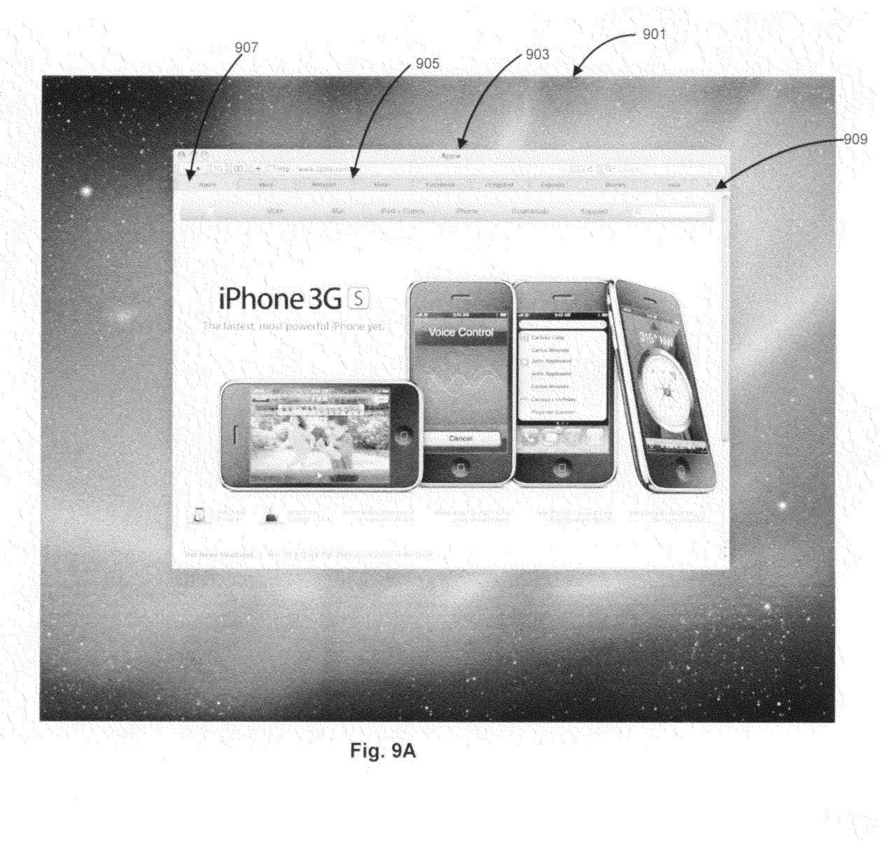

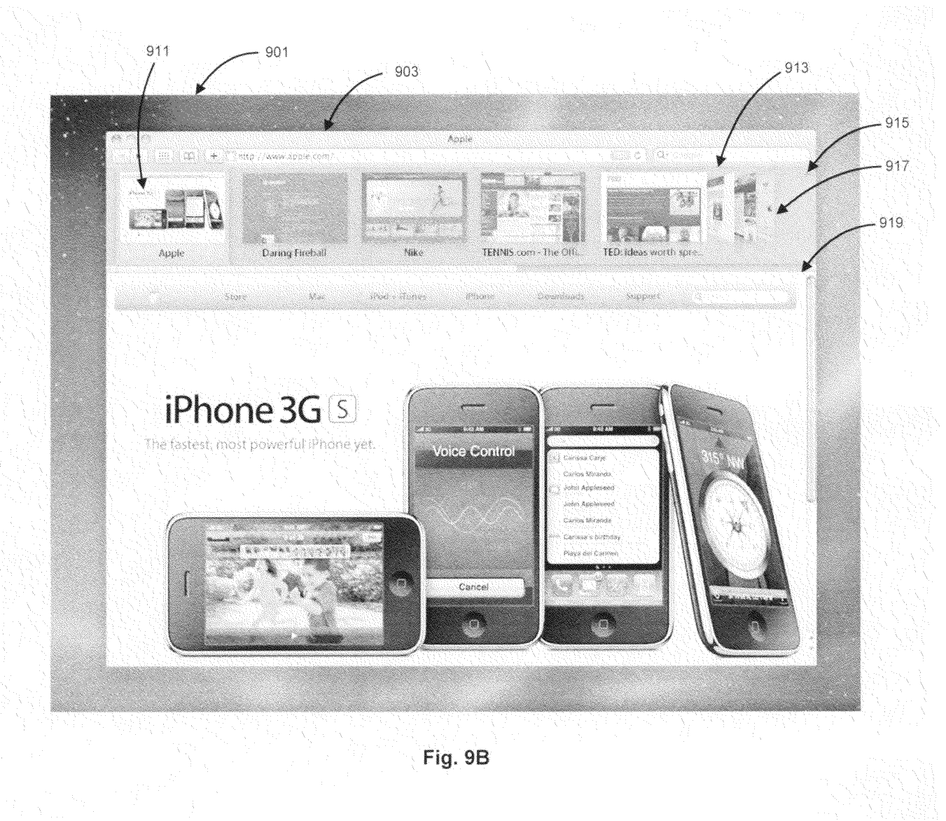

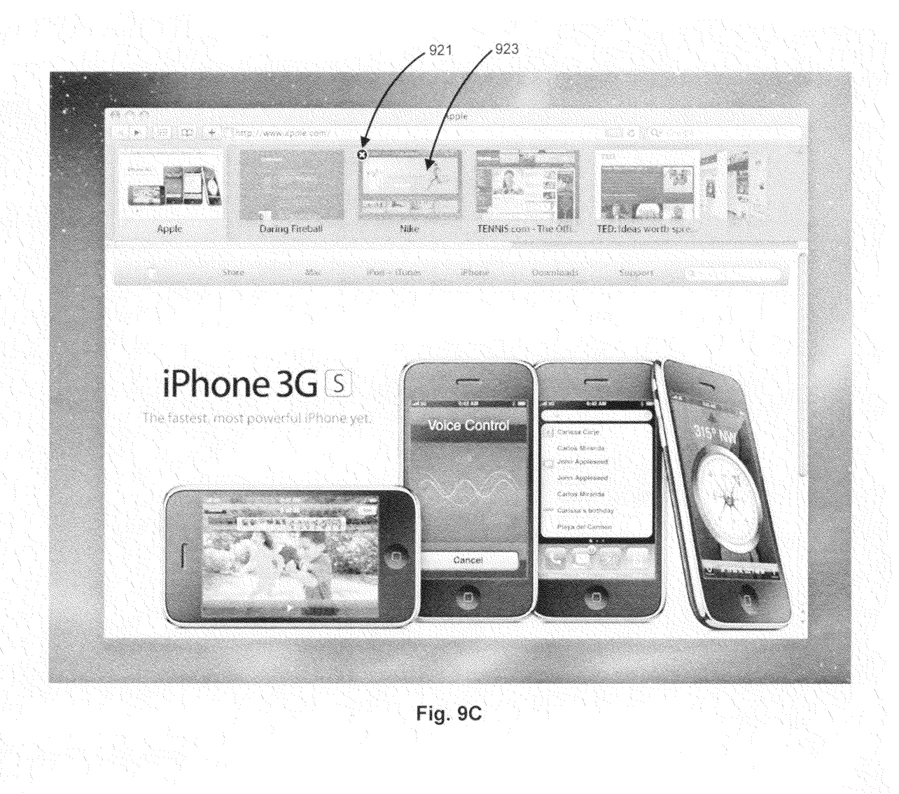

FIGS. 9A-9C show an example, through screen shots, of a user interface in which a tab bar in a window is expandable to display thumbnail tabs as snapshot images of presentations using the window. In FIG. 9A, display area 901 including window 903 may be a portion of a display screen in a display device of a data processing system. Window 903 may be associated with a browser application. Tab bar 905 may be a collapsed tab bar including tabs corresponding to separate documents or URLs for the browser application. Tab 907 having a label “Apple” may be highlighted to indicate a currently selected tab for contents currently displayed in window 903. Indicator 909 may represent a user interface for accessing additional tabs in tab bar 905.

Turning now to FIG. 9B, expanded tab bar 913 may include a cover flow of thumbnail tabs corresponding to tabs in a collapsed tab bar 905 of FIG. 9A. Thumbnail tab 911 may be a front view image corresponding to tab 907 representing a common URL labeled as “Apple”. In contrast, thumbnail tabs 917 may be presented in a slanted view to indicate an order of cover flow. Indicator 915 (e.g. a button), similar to indicator 909 of FIG. 5A, may represent a user interface for accessing additional thumbnail tabs in tab bar 913. For example, clicking on indicator 915 may cause thumbnails tabs to shift to the left to reveal additional thumbnail tabs slanted in from the right side of tab bar 913. A user may scroll thumbnail tabs in expanded tab bar 913 via scroll bar 919. The bottom edge of collapsed bar 905 may morph into scroll bar 919 when collapsed tab bar 905 expands to tab bar 913. In FIG. 9C, button 921 may indicate that thumbnail tab 923 is selected to be closed. For example, a user may move a cursor over tab 923 and click on a close button or click a menu item for closing tab 923.

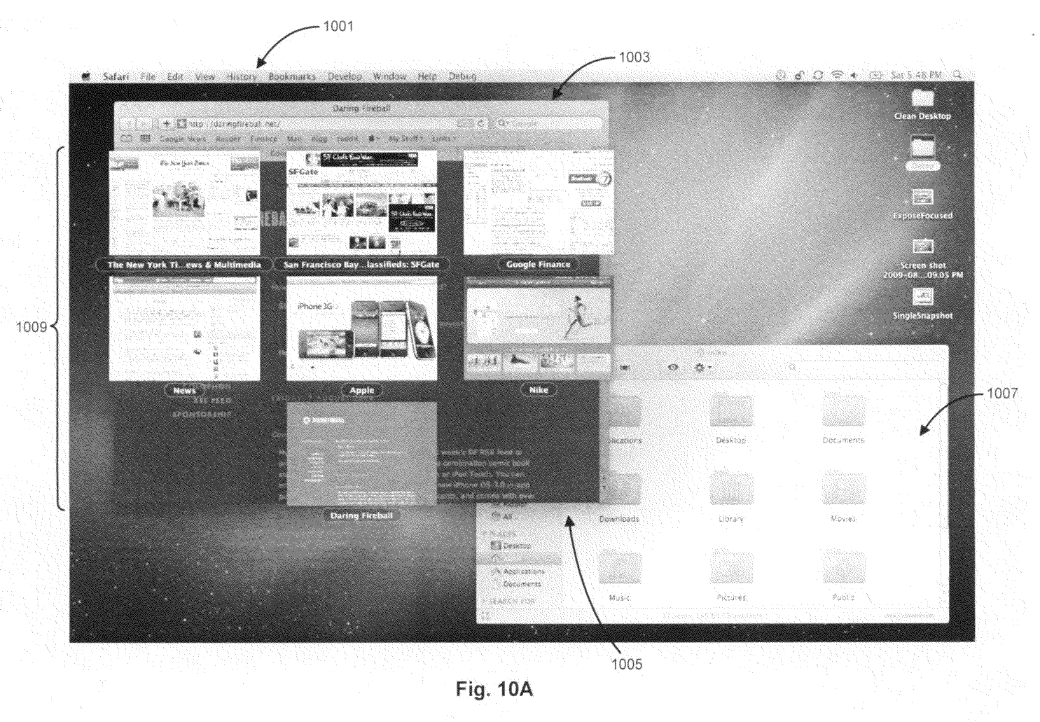

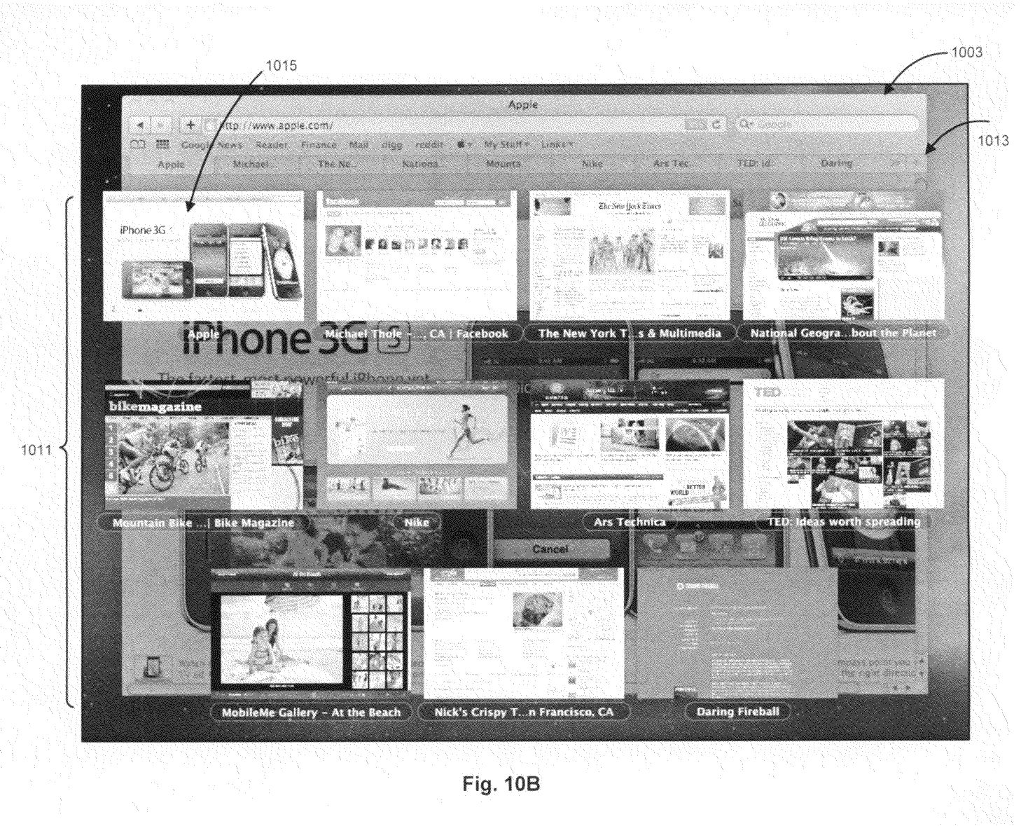

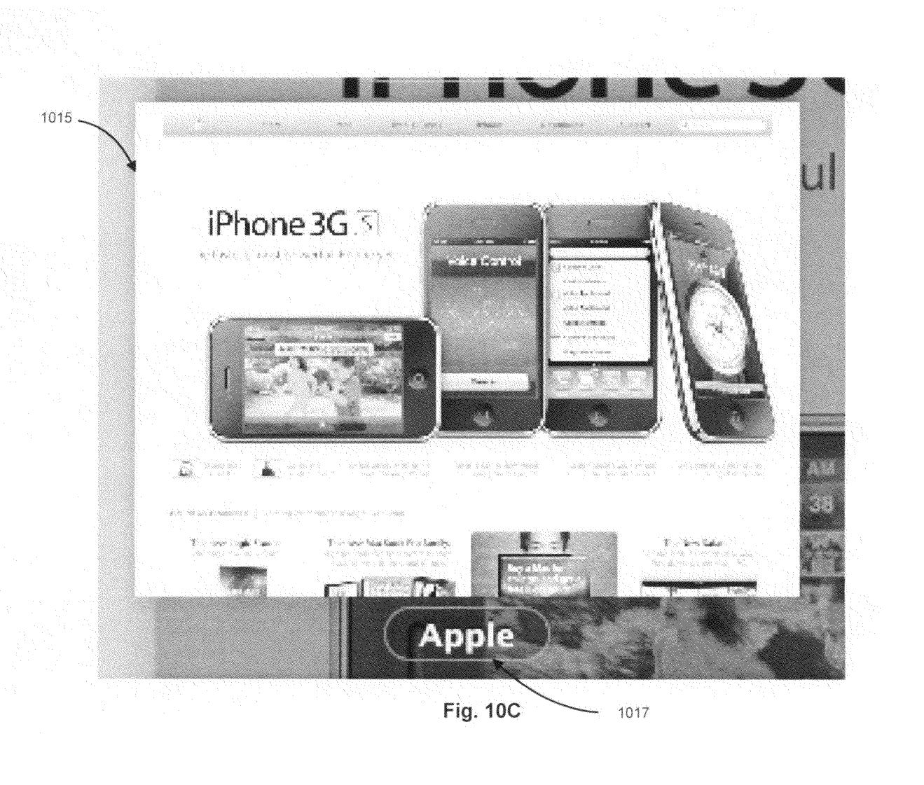

FIGS. 10A-10C show an example, through screen shots, of a user interface in which all the tabs in a window are exposed as snapshot images on top of the window. In the example provided in FIG. 10A, area 1001 may be a desktop window including a darkened window 1003 for displaying seven tabs as snapshot images in exposé mode 1009 in a display area larger than window 1003. A surrounding area 1005 around window 1003 may be darkened with a smooth change of degree of darkness depending on how far away from window 1003. Other parts of desktop area 1001 such as area 1007 may remain clear and functional without being affected by presenting tabs of window 1003 in an exposé mode 1009.

Turning now to FIG. 10B, eleven tabs as snapshot images including snapshot image 1015 are presented in an exposé mode 1011 for window 1003 corresponding to tabs in collapsed tab bar 1013. Snapshot images 1011 may be arranged in a left to right and top to bottom order in a grid view, aligned and centered, according to an order of the tabs displayed in tab bar 1013. FIG. 10C shows an enlarged view of snapshot image 1015 representing a snapshot of window 1003 appended beneath with a text label 1017 on a semi-transparent background.

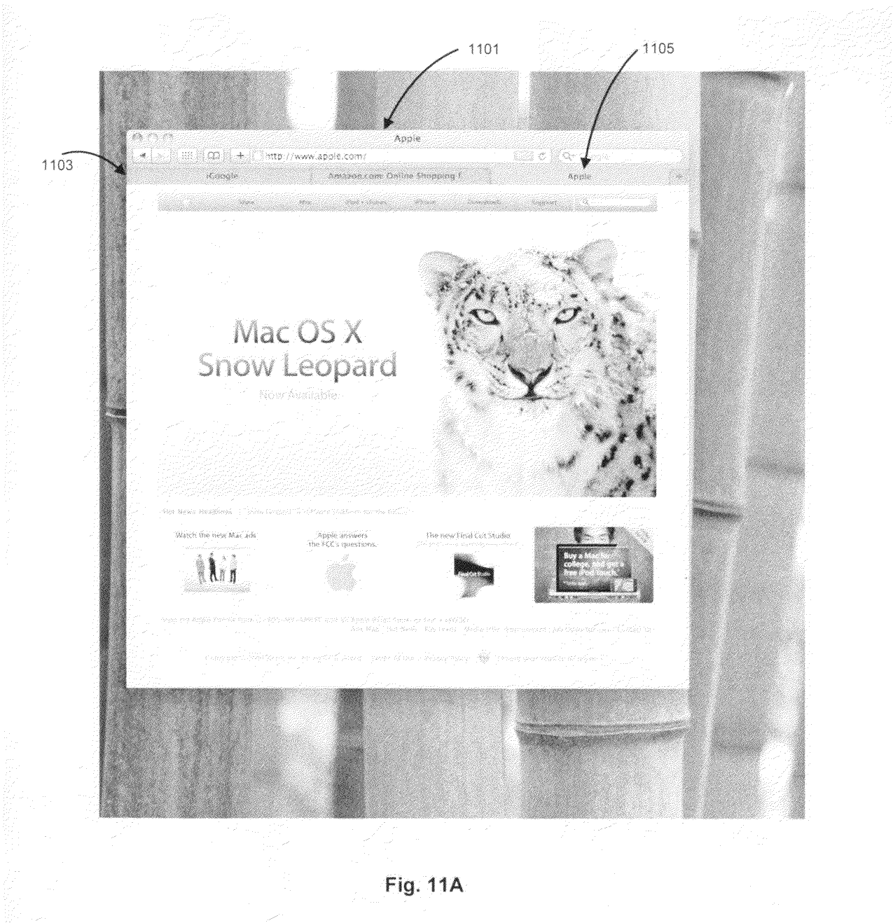

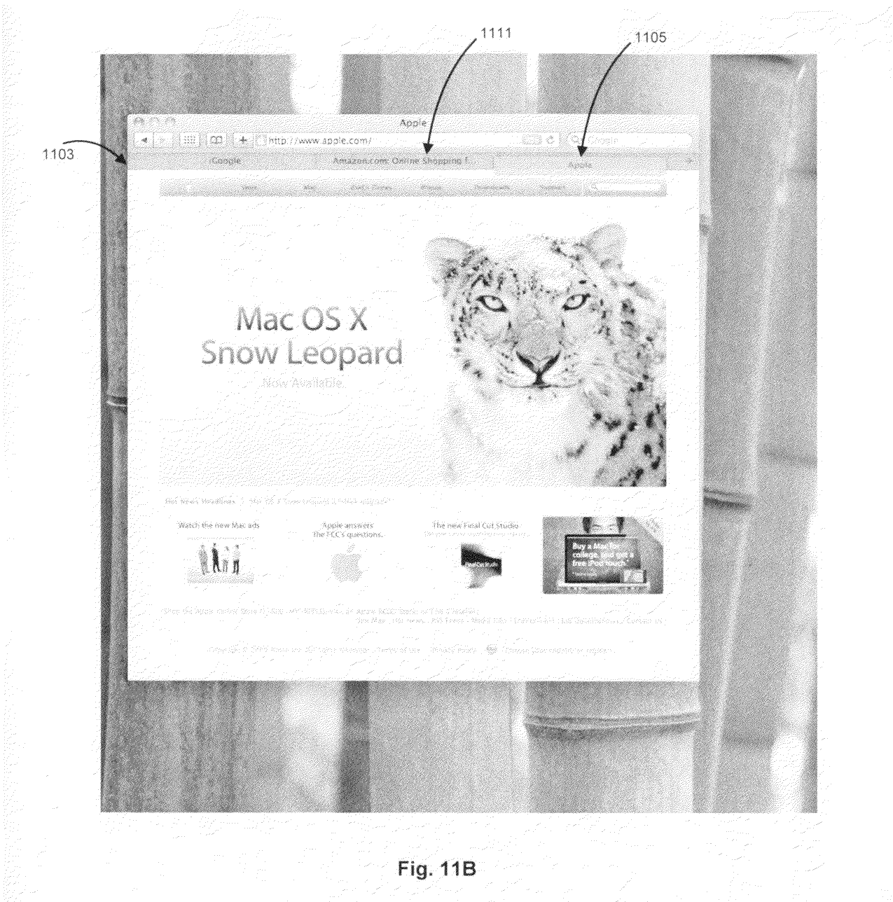

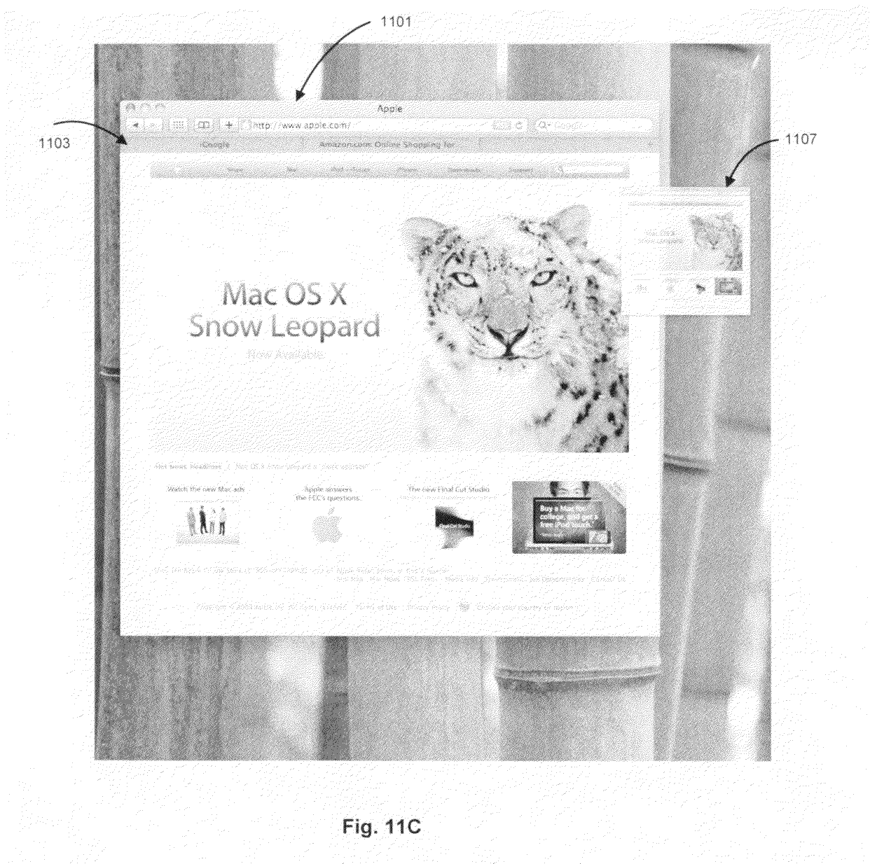

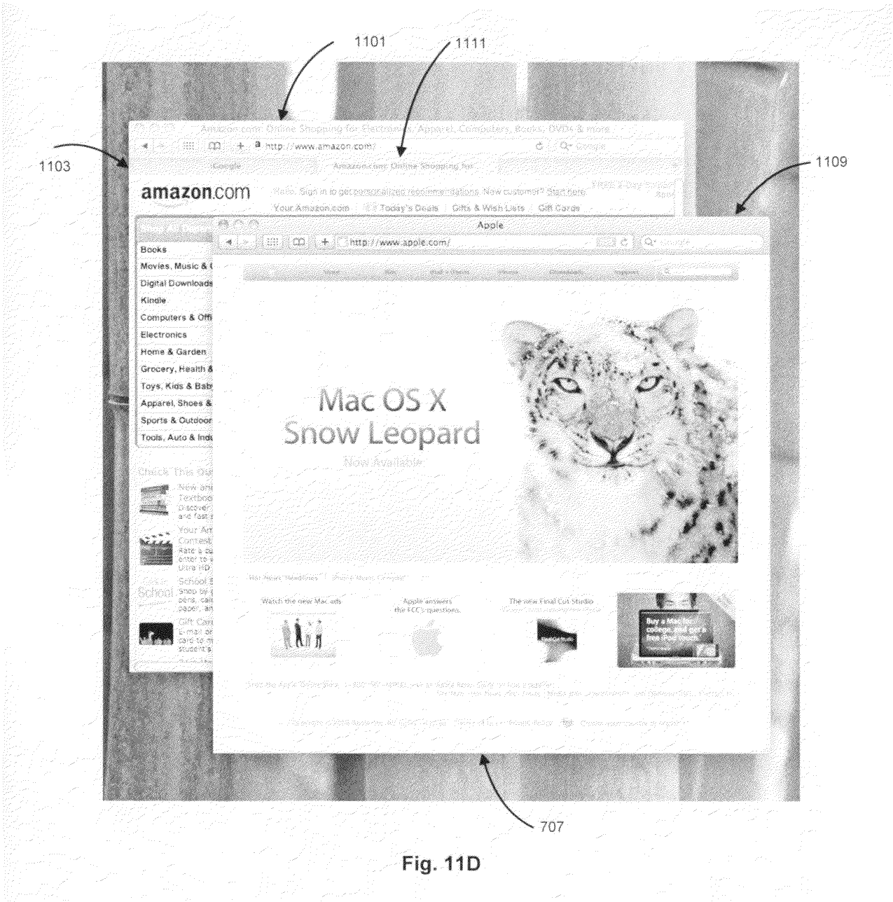

FIGS. 11A-11D show an example, through screen shots, of a user interface for dragging a tab out of a tab bar to generate a new window with contents of the dragged tab. In the example provided by FIG. 11A, window 1101 may include tab bar 1103 for a browser application opening a document corresponding to tab 1105 highlighted as currently selected tab in tab bar 1103. In FIG. 11B, tab 1105 is just being dragged from tab bar 1103, where tab 1111 may be ordered next to tab 1105. Turning now to FIG. 11C, tab 1105 may be morphed into preview window 1107 at a location outside of tab bar 1103. Tab bar 1103 may be updated by removing tab 1105. Preview window 1107 may represent a snapshot of window 1101 used by a browser opening a document corresponding to tab 1105. In FIG. 11D, preview window 1107 may expand into window 1109 created, for example, when a user releases a mouse button at a destination location of preview window 1107 while dragging tab 1105 of FIG. 11A out of tab bar 1103. Tab 1111 next to tab 1105 in FIG. 11B may be selected as currently selected tab to update window 1101 when new window 1109 is created.

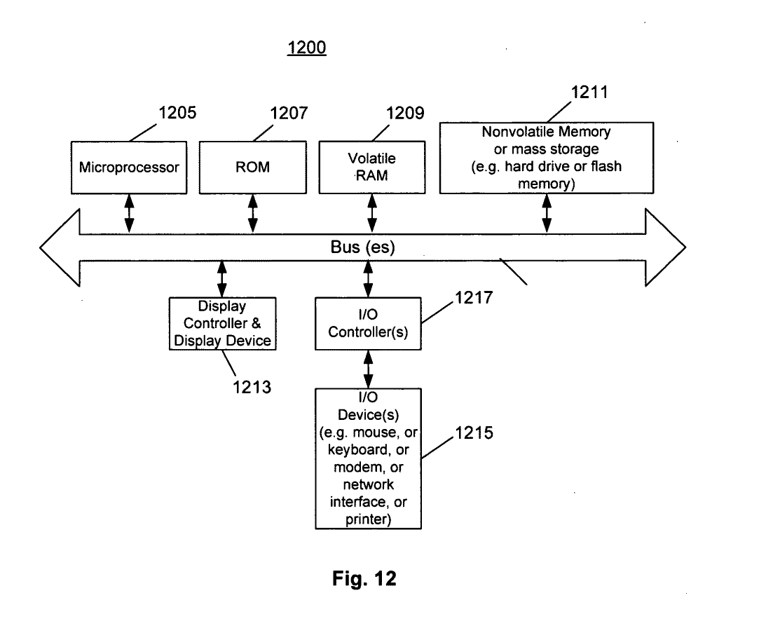

FIG. 12 shows one example of a data processing system such as a computer system, which may be used with one embodiment the present invention. For example, the system 1200 may be implemented as a part of the system shown in FIG. 5. Note that while FIG. 12 illustrates various components of a computer system, it is not intended to represent any particular architecture or manner of interconnecting the components as such details are not germane to the present invention. It will also be appreciated that network computers and other data processing systems which have fewer components or perhaps more components may also be used with the present invention.

As shown in FIG. 12, the computer system 1200, which is a form of a data processing system, includes a bus 1203 which is coupled to a microprocessor(s) 1205 and a ROM (Read Only Memory) 1207 and volatile RAM 1209 and a non-volatile memory 1211. The microprocessor 1205 may retrieve the instructions from the memories 1207, 1209, 1211 and execute the instructions to perform operations described above. The bus 1203 interconnects these various components together and also interconnects these components 1205, 1207, 1209, and 1211 to a display controller and display device 1213 and to peripheral devices such as input/output (I/O) devices which may be mice, keyboards, modems, network interfaces, printers and other devices which are well known in the art. Typically, the input/output devices 1215 are coupled to the system through input/output controllers 1217. The volatile RAM (Random Access Memory) 1209 is typically implemented as dynamic RAM (DRAM) which requires power continually in order to refresh or maintain the data in the memory.

The mass storage 1211 is typically a magnetic hard drive or a magnetic optical drive or an optical drive or a DVD RAM or a flash memory or other types of memory systems which maintain data (e.g. large amounts of data) even after power is removed from the system. Typically, the mass storage 1211 will also be a random access memory although this is not required. While FIG. 12 shows that the mass storage 1211 is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface or wireless networking interface. The bus 1203 may include one or more buses connected to each other through various bridges, controllers and/or adapters as is well known in the art.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

We claim:

1. A computer implemented method for presenting tabs in a window to interface with a user, the method comprising:
generating a thumbnail image for each of the tabs, in a tab bar, based on a snapshot of the window providing an interface for a presentation corresponding to the tab;
displaying an expanded tab bar to replace the tab bar in the window, the expanded tab bar including at least one of the thumbnail images;
displaying, in response to a command received while the expanded tab bar is displayed, snapshot images arranged in a two dimensional grid over an area covering at least a center portion of the window, the snapshot images corresponding to the thumbnail images in the expanded tab bar; and
in response to detecting a user interface action on a particular one of the snapshot images in the two dimensional grid, the particular snapshot image corresponding to a particular one of the presentations, updating the window to provide an interface for the particular presentation.

2. The method of claim 1, wherein generating the thumbnail image comprises:
taking a snapshot of the window providing the interface for the presentation, wherein the thumbnail image includes the snapshot reduced in size.

3. The method of claim 2, wherein the window providing the interface for the presentation is rendered live at time of the snapshot.

4. The method of claim 1, wherein the tab and the thumbnail image for the tab are labeled with a text description of the corresponding presentation.

5. The method of claim 4, wherein the tabs correspond to separate presentations performed by a single application via the window, wherein each presentation corresponds to a separate document opened by the application and wherein the text description indicates a corresponding document opened by the application.

6. The method of claim 1, further comprising:
detecting a dragging operation to expand the tab bar, the dragging operation being associated with an edge of the tab bar.

7. The method of claim 1, wherein the user interface action is a selection operation to select the particular presentation corresponding to the particular thumbnail image.

8. The method of claim 1, wherein the snapshot images are resized from the thumbnail images.

9. The method of claim 1, wherein the displaying of the snapshot images comprises:
morphing the thumbnail images in the expanded tab bar; and
flowing at least one of the thumbnail images from the expanded tab bar into a corresponding snapshot image in the two dimensional grid.

10. The method of claim 9, wherein updating the window comprises:
removing the snapshot images, that are arranged in the two dimensional grid, by animating the snapshot images back to the thumbnail images in the expanded tab bar.

11. The method of claim 1, wherein the tabs are arranged in an order in the tab bar, wherein the snapshot images are arranged in a two dimensional order based on the order in the two dimensional grid, the method further comprises:
moving at least one of the snapshot images among the two dimensional grid to update the two dimensional order; and
reordering the tabs in the tab bar according to the updated two dimensional order.

12. A computer implemented method for presenting tabs in a window on a display screen to interface with a user, the method comprising:
generating snapshot images for the tabs corresponding to separate presentations which use the window, each snapshot image containing content of r a presentation corresponding to a tab on the window;
determining an area covering a center portion of the window on the display screen according to constraints including a minimal visible image size and an available area on the display screen surrounding the window; and
displaying the snapshot images arranged in a two dimensional grid for identifying the separate presentations over the area encompassed by the surrounding area of the window.

13. The method of claim 12, wherein the display of the snapshot images comprises darkening the window and the surrounding area of the window.

14. The method of claim 12, wherein the tabs are ordered in a tab bar according to an order, and wherein the display of the snapshot images comprises configuring the snapshot images in the area according to the order.

15. The method of claim 14, further comprising:
flowing the snapshot images from the tab bar to the area while morphing each tab into a corresponding snapshot image.

16. The method of claim 15, wherein the flowing comprises placing the snapshot images in the area sequentially in a left to right and top to bottom manner following the order of the corresponding tabs in the tab bar.

17. The method of claim 16, further comprising:
in response to detecting a selection operation on a particular snapshot image in the area, updating the window to provide an interface for a particular presentation corresponding to the particular snapshot image selected; and
clearing the snapshot images from the area.

18. The method of claim 16, wherein the clearing comprises:
morphing each snapshot image back to a corresponding tab in the tab bar while lightening up the window and the surrounding area.

19. The method of claim 18, wherein the morphing the snapshot images comprises:
shrinking the snapshot images; and
moving the snapshot image back in the tab bar in a sequence according to the order of the tabs in the tab bar.

20. The method of claim 12, wherein the screen display includes a display resolution and where the minimal visible image size is determined according to the display resolution.

21. The method of claim 12, wherein the constraints include a total number of the tabs in the tab bar.

22. The method of claim 21, wherein the constraints include a maximum snapshot image size and wherein each snapshot image is of the maximum snapshot image size if the window is of a size larger than the maximum snapshot image size times the total number of the tabs in the tab bar.

23. The method of claim 12, further comprising:
detecting a dragging operation to move one of the tabs from a tab bar of the window to a destination location;
determining if the destination location is outside of the tab bar; and
generating a preview window for the tab according to a corresponding presentation using the window, the preview window representing a snapshot of the window providing an interface for the corresponding presentation; and
displaying the preview window at the destination location to indicate a new window for the corresponding presentation.

24. The method of claim 23, further comprising:
displaying the new window at the location, the new window providing an interface for the corresponding presentation; and
updating the window to remove the tab from the tab bar.

25. A machine-readable storage medium having instructions, when executed by a machine, cause the machine to perform a method, the method comprising:
generating a thumbnail image for each of the tabs, in an expanded tab bar, based on a snapshot of the window providing an interface for a presentation corresponding to the tab;
morphing the thumbnail images from the expanded tab bar into snapshot images arranged in a two dimensional grid over an area covering at least a center portion of the window; and
in response to detecting a user interface action on a particular one of the snapshot images in the two dimensional grid, the particular snapshot image corresponding to a particular one of the presentations, updating the window to provide an interface for the particular presentation.

26. A machine-readable storage medium having instructions, when executed by a machine, cause the machine to perform a method, the method comprising:
generating snapshot images for the tabs corresponding to separate presentations which use the window, each snapshot image containing content of a presentation corresponding to a tab on the window;
determining an area covering a center portion of the window on the screen display according to constraints including a minimal visible image size and an available area on the display screen surrounding the window; and
displaying the snapshot images arranged in a two dimensional grid for identifying the separate presentations over the area encompassed by the surrounding area of the window.

27. An apparatus, comprising:
a memory storing executable instructions;
a user interface device having a display screen;
a processor coupled to user interface device and the memory to execute the executable instructions from the memory for switching among a plurality of presentations for a window on the display screen, the processor being configured to:
generate a thumbnail image for each of the tabs, in the tab bar, based on a snapshot of the window providing an interface for a presentation corresponding to the tab;
display an expanded tab bar to replace the tab bar in the window, the expanded tab bar including at least one of the thumbnail images;
morph the thumbnail images from the expanded tab bar into snapshot images arranged in a two dimensional grid over an area covering at least a center portion of the window; and
in response to detecting a user interface action on a particular one of the snapshot images in the two dimensional grid, the particular snapshot image corresponding to a particular one of the presentations, update the window to provide an interface for the particular presentation.
